(19) United States
(12) Patent Application Publication
(10) Pub. No.: US 2013/0327305 A1
(43) Pub. Date: Dec. 12, 2013

(54) CAPACITOR DISCHARGE COIL CONVERTER FOR USE WITH DIGITAL INDUCTIVE IGNITION SYSTEMS

(71) Applicant: Arrow Engine Company, Tulsa, OK (US)

(72) Inventors: Billie Eugene Baker, Bixby, OK (US); Jamey Jameson, Broken Arrow, OK (US)

(21) Appl. No.: 13/910,190

(22) Filed: Jun. 5, 2013

Related U.S. Application Data
(60) Provisional application No. 61/656,155, filed on Jun. 6, 2012.

(51) Int. Cl. F02P 3/08

(52) U.S. Cl. CPC F02P 3/0815
USPC 123/597

(57) ABSTRACT

Disclosed is a capacitive discharge coil converter for an internal combustion engine. The internal combustion engine includes a digital inductive ignition system and a plurality of capacitive discharge ignition coils. The internal combustion engine includes a capacitive discharge coil converter for each capacitive discharge ignition coil. Each capacitive discharge coil converter is electrically connected between the digital inductive ignition system and a corresponding one of the capacitive discharge ignition coils.

### CROSS REFERENCE TO RELATED APPLICATION

This application claims the benefit of U.S. Provisional Application No. 61/656,155 filed Jun. 6, 2012, which is hereby incorporated by reference.

### BACKGROUND

The present invention, as exemplified by this disclosure, pertains broadly to the use of a capacitive discharge ignition (CDI) coil as part of an electronic ignition system of an internal combustion engine. More specifically the present disclosure details the construction and use of a capacitor discharge coil converter. The converter creates an interface between the existing CDI coil and an engine control module (ECM), which is part of a digital inductive ignition system. The converter was developed to facilitate the use of a capacitive type ignition coil with an inductive type, digitally controlled ignition system.

Spark plug based internal combustion engines require some type of ignition system. One function of the ignition system is to generate sufficient energy to a create spark sufficient to initiate combustion of the fuel-air mixture. A second function of the ignition system is to control the timing of the spark in hopes of having the engine operate at its optimal capacity and/or efficiency. There are mechanical ignition systems, electronic ignition systems, and distributorless ignition systems. Briefly, mechanical systems include the ignition switch, the ignition coil, spark plugs and the distributor. The distributor includes ignition points. Electronic ignition systems are similar to mechanical ignition systems except that they use electronic timing devices instead of ignition points. Generally, an electronic control module, separate from the distributor, guides the flow of current in the ignition coil primary circuit. Distributorless ignition systems rely on an internal computer instead of a distributor.

One of the disadvantages of the mechanical ignition system is the use of breaker points (ignition points) to interrupt the low-voltage, high-current through the primary winding of the coil. The points are subject to mechanical wear and require regular adjustment to compensate for such wear. In addition, the spark voltage is dependent on having contact effectiveness and poor sparking can lead to lower efficiency. Electronic ignition systems are an attempt to try and address at least some of these issues.

Capacitive discharge ignition (CDI) represents one type of electronic ignition system. The CDI technology was originally developed to address the issue of longer charging times associated with high inductance coils used in inductive discharge ignition (IDI) systems. Engines which include an IDI system rely on the electric conductance at the coil to produce high-voltage electricity to the spark plugs as the magnetic field collapses when the current to the primary coil winding is disconnected. In a CDI system, a charging circuit charges a high voltage capacitor. This capacitor discharges its output to the ignition coil before reaching the spark plug. As should be understood, while these two types of electronic ignition systems have a similar objective and some structural similarities, they employ different operational principles.

In the present disclosure an existing engine using a CDI coil is being integrated with a new digital inductive ignition system. The key to being able to do so is the use a novel and unobvious capacitor discharge coil converter. During the design and development of the new digital inductive ignition system, it was recognized that there were certain design issues which had to be addressed. First, it became clear that the existing CDI coil could not be used directly with the digital inductive ignition system being developed. The dwell time (charge time) supplied by the digital system was much too long for the CDI coil and caused it to overheat and eventually break down. The electrical noise produced by the starting system, charging system and ignition of the engine made use of the electronic circuits and some components very difficult. Shortening the dwell time for the CDI coil resulted in the coil firing “out of time” with the digital system and a mix of CDI and inductive coils could not be used. Since there were no available existing circuits or devices which would adapt a CDI coil to be used with the new digital inductive ignition system, a suitable converter, as disclosed herein, needed to be designed and constructed. The design and development of the disclosed converter in effect essentially takes a standard capacitive ignition coil and allows it to be used as an inductive type, allowing the coil to be digitally controlled by an electronic ignition system.

In terms of existing technology which might be available to address the issue outlined above, it was learned that there were circuit designs which would operate a CDI coil. However, these circuit designs did not address the issue of discharge timing, nor the issue of noise reduction or discrimination. Any digital ignition control units which might be available were designed around the parameters of inductive-type coils. Simply stated, no existing circuits or devices were identified which would adapt a CDI coil to the digital inductive ignition system being developed. As a result of this deficiency in the art, a new circuit was called for which would provide an electrical interface (i.e. a converter) between the CDI coil and the digital inductive ignition system being developed. The digital inductive ignition system being developed is based in part on interfacing with and utilization of the engine control module.

### SUMMARY

Disclosed is a capacitive discharge coil converter for an internal combustion engine. The internal combustion engine includes a digital inductive ignition system and a plurality of capacitive discharge ignition coils. The internal combustion engine includes a capacitive discharge coil converter for each capacitive discharge ignition coil. Each capacitive discharge coil converter is electrically connected between the digital inductive ignition system and a corresponding one of the capacitive discharge ignition coils.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a side elevational view of an internal combustion engine which includes a plurality of capacitor discharge coil converters according to the present disclosure.

FIG. 2 is an enlarged, exploded view of one capacitor discharge coil converter of the FIG. 1 engine.

FIG. 3 is a block diagram showing the electrical connections and signals from an engine control module of the FIG. 1 engine to a spark plug of the FIG. 1 engine.

FIG. 4 is an electrical schematic of a representative converter circuit for the FIG. 3 block diagram, according to one embodiment of the present disclosure.

FIG. 5 is a bottom plan view of one side of a printed circuit board (PCB) corresponding to portions of the FIG. 4 electrical schematic.

FIG. 6 is a top plan view of the opposite side of the FIG. 5 PCB corresponding to portions of the FIG. 4 electrical schematic.

FIG. 7 is a front elevational view of the FIG. 5 PCB mounting to a bracket which is assembled to the capacitor discharge ignition coil of FIG. 2.

FIG. 8 is an exploded view of the FIG. 7 assembly.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

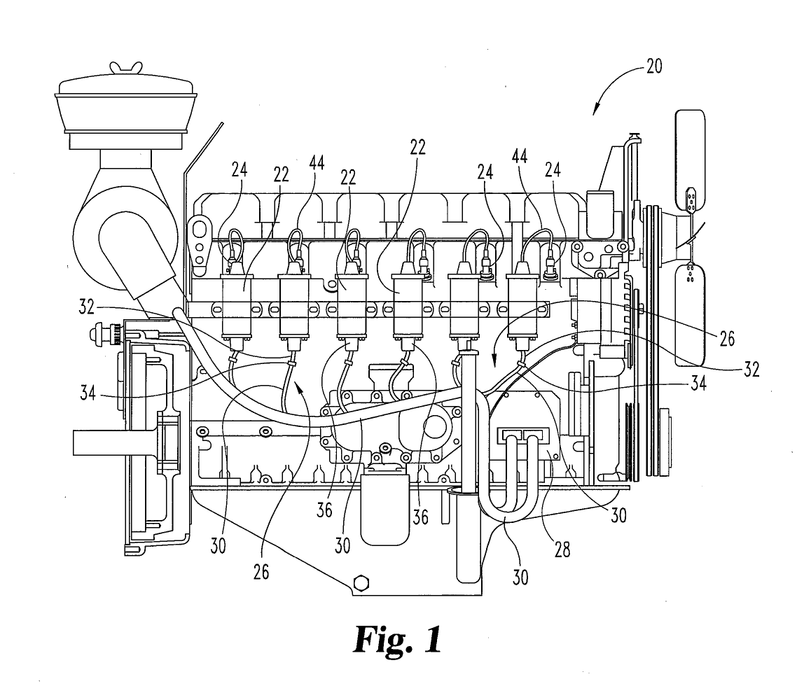

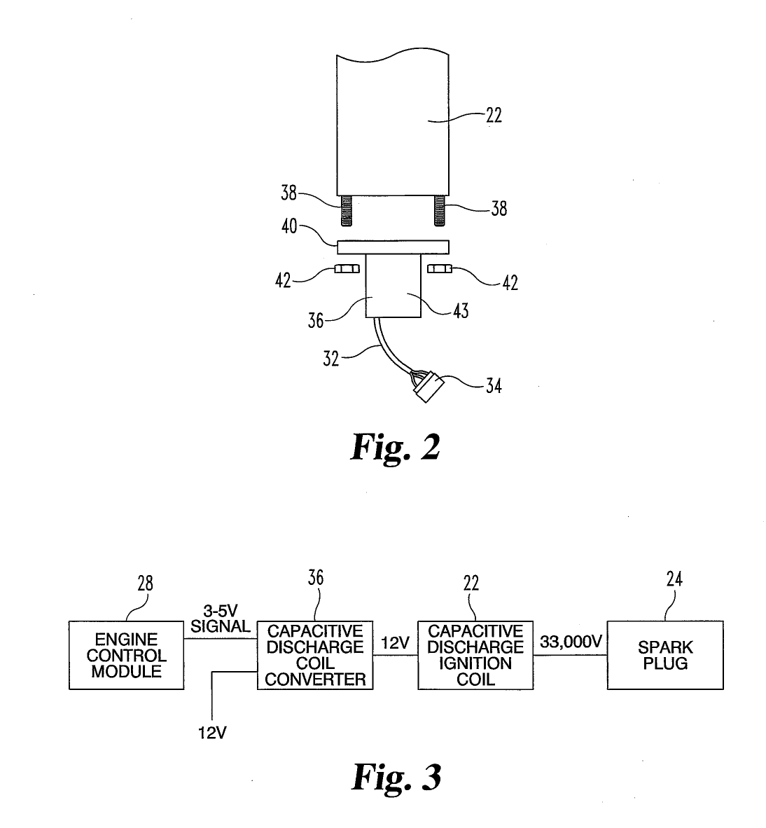

Referring to FIG. 1 there is illustrated an engine 20 which includes capacitive discharge ignition (CDI) coils 22, a cooperating spark plug 24 connected to each coil and electrical connections 26 from the engine control module (ECM) 28 to each CDI coil 22. The electrical connections 26 include the engine wiring harness 30 and the individual cables 32 from the converter 36 of each CDI coil. A connector 34 on each cable 32 is used to electrically connect the converter 36 of each CDI coil to the engine wiring harness 30 and thus to the ECM 28. As further illustrated in FIG. 2, each individual cable 32 is part of the converter wiring and does not directly attach or connect to the corresponding CDI coil 22. Instead, each cable 32 is hard wired to the corresponding capacitive discharge coil converter 36 which mechanically attaches and electrically connects to a corresponding CDI coil 22. The electrical interface between the ECM 28 and each CDI coil 22 which is correspondingly provided by each converter 36, enables the ECM to control the operation of each CDI coil 22.

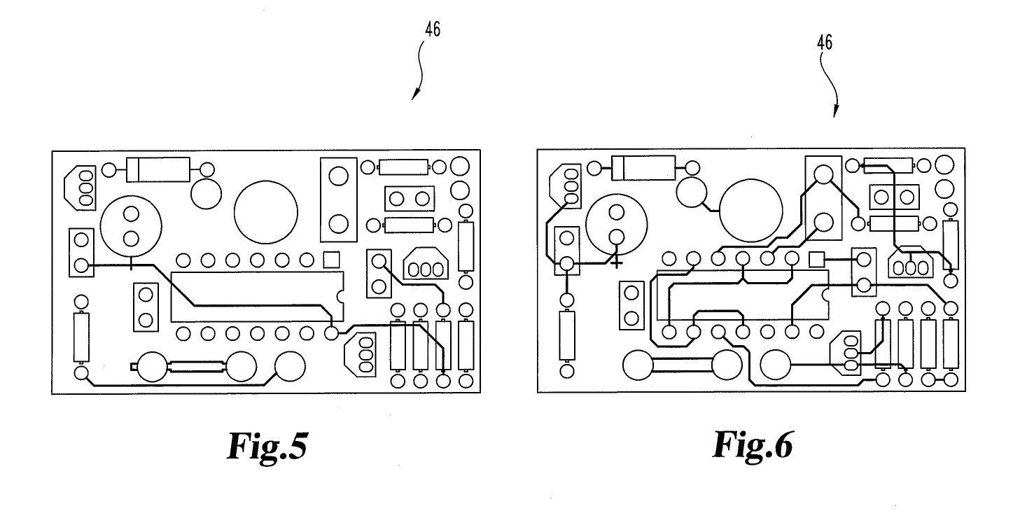

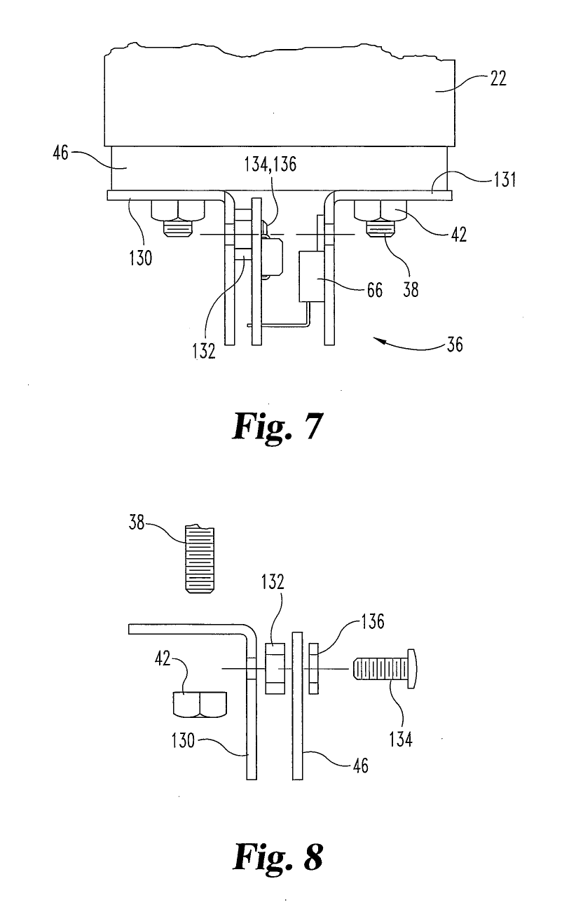

With continued reference to FIG. 2, the mechanical attachment of each converter 36 to its corresponding CDI coil 22 is illustrated. The exploded view of this mechanical attachment is essentially the same for each converter/CDI coil combination of engine 20. As illustrated, threaded posts 38 are provided as part of the CDI coil 22 and the converter 36 includes a mounting portion 40 with clearance holes (not illustrated) which receive the threaded posts. Hex nuts 42 are used to complete this mechanical connection which securely attaches each converter 36 to its corresponding CDI coil 22. A protective cover 43 is shown in FIG. 2 and has been removed in FIG. 7 so as to illustrate the mounting arrangement of the printed circuit board (PCB) 46, see FIGS. 5-8. Although a “conventional” PCB 46 has been illustrated (using through holes for component leads), surface-mount technology (SMT) can also be used as a further design option. By using SMT the components are mounted directly to the surface of the PCB and this can offer some size reduction to the overall size of the completed PCB.

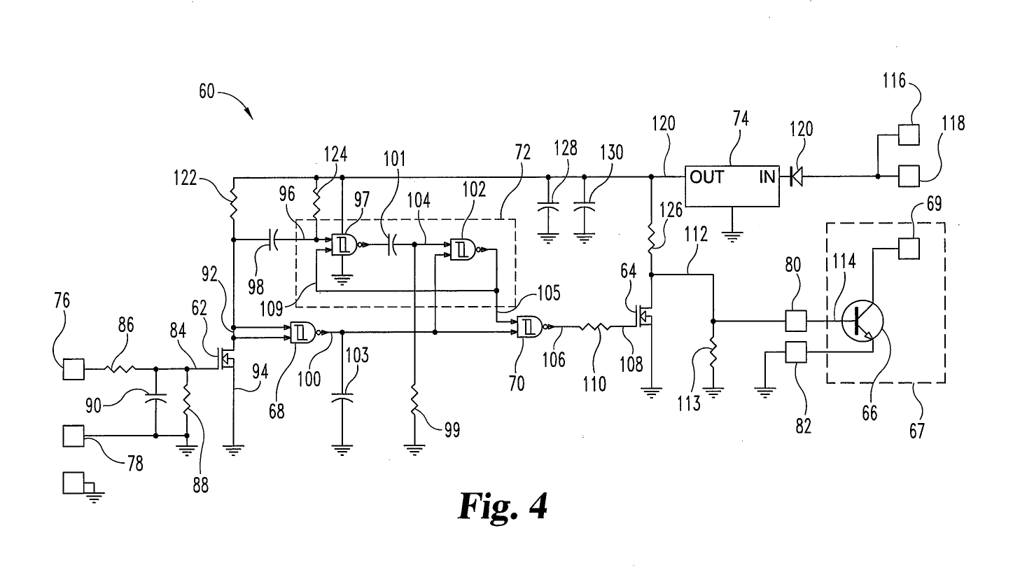

The basics of the electrical connections are illustrated in the flow or block diagram of FIG. 3. This block diagram shows the electrical connections and signals from the ECM 28 to each spark plug 24. As shown, the ECM 28 communicates with the converter 36 via a pulse which may be a 3-volt to 5-volt timing signal (i.e. pulse). The converter 36 is powered by the battery (12 v) associated with engine 20. The 12 v power connection to each CDI coil 22 is ramped up to approximately 33,000 v which is delivered to the corresponding spark plug 24. Each spark plug 24 is connected to a corresponding CDI coil 22 via a connecting cable 44 (see FIG. 1). The timing pulse from the ECM 28 causes an isolated gate transistor to turn on allowing sufficient current to flow through the primary winding of the CDI coil 22 to cause a spark to occur across the spark gap of the engine spark plug 24. A more detailed circuit schematic explanation (i.e. its operation) follows in conjunction with a description of its layout and construction, see FIG. 4.

FIG. 4 shows a schematic diagram of a circuit 60 according to one embodiment of the present disclosure. The circuit 60 comprises transistors 62, 64, and 66, nand gates 68 and 70, monostable flip-flop 72, and voltage regulator 74. Various capacitors and resistors are also included, as discussed further below. These circuit components can be selected for either through hole assembly into the PCB or surface mounting (i.e. SMT).

The circuit 60 generally functions to reduce the pulse width of timing pulses received from an external digitally controlled ignition system. The pulses output by the circuit 60 have a reduced width which is required for proper operation of a capacitive discharge ignition coil. In addition, the circuit 60 prevents unintentional coil operation or misfires due to noise. The input timing pulses are received at input terminals 76 and 78, with the shortened pulses output at terminals 80 and 82. The shortened output pulses are used to drive the input of transistor 66, which in turn allows current to flow through the primary winding of the capacitor discharge ignition coil. Transistor 66 is not mounted on PCB 46 and this is graphically represented by box 76 and the use of terminal 69.

Input terminal 76 is connected to the gate (node 84) of transistor 62 via resistor 86 as shown. Resistor 88 and capacitor 90 are connected between node 84 and ground to provide further biasing and noise filtering. The drain (node 92) of transistor 62 is connected to both inputs of nand gate 68, with the source (node 94) connected to ground. This implementation of nand gate 68 functions similar to that of an inverter. It shall be understood that other types of inverters known in the art may also be used.

Node 92 is further connected to a first input (node 96) of nand gate 97 within monostable flip-flop 72 via capacitor 98 as shown. The output (node 100) of nand gate 68 is connected to a first input of nand gate 102 within monostable flip-flop 72 and also to a first input of nand gate 70 as shown. Capacitor 101 is connected between the output of nand gate 97 and a second input 104 of nand gate 102. Capacitor 103 may also be connected between node 100 and ground. Resistor 99 is connected between a second input (node 104) of nand gate 102 and ground as shown.

The output (node 105) of monostable flip-flop 72 is connected to a second input 109 of nand gate 97 (within flip-flop 72) and further to the second input of nand gate 70. The output (node 106) of nand gate 70 is connected to the gate (node 108) of transistor 64 via resistor 110. The source (node 112) of transistor 64 is connected to the output terminal 80, which is further connected to the gate 114 of transistor 66. Resistor 113 is connected between node 112 and ground.

Voltage regulator 74 receives supply power from an external source connected to terminals 116 and/or 118. Blocking diode 120 is connected between the external source and the input of voltage regulator 74 as shown. The output (node 120) of regulator 74 supplies a constant voltage to the circuit components. More specifically, resistor 122 is connected between node 120 and node 92, resistor 124 is connected between node 120 and node 96, and resistor 126 is connected between node 120 and node 112. Capacitors 128 and 130 may also be connected between node 120 and ground to provide additional filtering.

Monostable flip-flop 72 is illustrated as implemented using nand gates, however other similar “one shot” implementations known in the art may also be used. As one non-limiting example, a resistor network may be used to achieve the one-shot functionality of monostable flip-flop 72.

Transistors 62 and 64 are preferably implemented as n-channel metal oxide field effect transistors (MOSFET), such at the BS 170 model transistor supplied by Fairchild Semiconductor. Transistor 66 is preferably implemented as an insulated gate bipolar transistor (IGBT). However, other types of transistors and switching devices may also be used to achieve the same switching functionality.

In operation, circuit 60 receives input timing pulses, at terminals 76 and 78, from a central processing unit (CPU) of an external digitally controlled ignition system. The pulses have an amplitude in the range of 3-5 volts and a pulse width in the range of 1.0 to 5.0 msec. The input pulses are first amplified and inverted by transistor 62. The leading edge of this now negative pulse is applied to the first input (node 96) of nand gate 97 within monostable flip-flop 72 to generate a time delay. At the same time, the negative pulse is applied to both inputs of nand gate 68 and is again inverted. The resulting pulse (node 100) is now a positive 10 volts and compares to the input pulse in time. The pulse is then directed to both the second input of the nand gate 102 and nand gate 70. By directing the node 100 pulse to nand gate 102, the monostable flip-flop 72 is prevented from operating unintentionally. This is because the flip-flop 72 can only operate when a 10 volt positive pulse is present at the input of nand gate 102. The node 100 pulse further controls the output of the nand gate 70, effectively cancelling the output of the flip flop 72 and only allowing a delayed, shorter-width pulse to appear at node 106.

The pulse output at node 106 is still negative in amplitude and is therefore inverted and amplified by transistor 64. The resulting positive pulse (node 112) is then directed to the gate (114) of the transistor 66, thereby activating transistor 66 and allowing current to flow through the capacitive discharge coil.

The majority of what comprises circuit 60 is arranged and packaged in one embodiment into a double-sided printed circuit board (PCB) 46. The component locations are shown by the bottom plan view of FIG. 5 and the top plan view of FIG. 6. The FIG. 5 illustration shows the component layout on the bottom surface of the PCB 46. FIG. 6 shows the component layout on the top (i.e. opposite side) surface of PCB 46. The FIG. 5 and FIG. 6 illustrations show only the actual PCB (double sided) as it would be configured after plating and screening, prior to the actual mounting or installing of the electrical components and the soldering of those electrical components into position with the desired electrical connections. The component outlines and references are typically ink screened onto the board as an aid for assembly. As noted, another option for the mounting and assembly of the electrical components onto PCB 46 is to use SMT. The circuitry does not change regardless of the mechanical layout and assembly technique used for PCB 46.

The PCB 46, as fully assembled with the corresponding electrical components in position, is mounted to its corresponding CDI coil 22, as illustrated in FIGS. 2 and 7. The FIG. 2 illustration is with cover 43 in position and thus the more instructive illustration is perhaps FIG. 7 which does not include the cover 43 and thereby permits a more detailed illustration of the components and the mechanical packaging. Two L-shaped brackets 130 and 131 are used and collectively these two brackets 130, 131 comprise the mounting portion 40. A clearance hole in each bracket 130, 131 receives a corresponding one of threaded posts 38 and a hex nut 42 then completes each mechanical connection.

The PCB 46 is mounted to one bracket 130 and is electrically insulated therefrom by synthetic (i.e. non-electrically conductive) spacer 132. Threaded fastener 134 and washer 136 provide a conductive mounting and connection. Transistor 66 which is not mounted onto PCB 46 is mounted onto the other bracket 131 and the connection between transistor 66 and the PCB 46 is illustrated in FIG. 7. The FIG. 8 illustration is an exploded view of the PCB 46 mounting to bracket 130. The packaging and mounting of PCB 46 may change if SMT is employed as an optional assembly method for PCB 46. It is likely to see a packaging modification if SMT is employed, though the functionality remains the same.

The use of converter 36 enables the desired operational interface between the digital conductive ignition system (newly developed) and the existing CDI coil in an efficient manner. The circuitry design used in converter 36 addresses the dwell time issue (overheating) and the electrical noise issue, as previously noted. Since there were no prior art circuits or devices available at the time of conception which would adapt a CDI coil to be used with the planned digital inductive ignition system, the disclosed converter was developed, including the disclosed circuitry, packaging and mounting.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. Other circuit arrangements may be utilized to achieve the described functionality. All publications, patents, and patent applications cited in this specification are herein incorporated by reference as if each individual publication, patent, or patent application were specifically and individually indicated to be incorporated by reference and set forth in its entirety herein.

1. An internal combustion engine including a digital inductive ignition system and a plurality of capacitive discharge ignition coils, said internal combustion engine comprising:
a plurality of capacitive discharge coil converters, each converter of said plurality of converters being electrically connected between said digital inductive ignition system and a corresponding one of said capacitive discharge ignition coils, wherein each converter of said plurality of converters is constructed and arranged for producing a shorter, usable pulse for its corresponding capacitive discharge ignition coil.

2. The internal combustion engine of claim 1 wherein each converter of said plurality of converters includes a plurality of nand gates.

3. The internal combustion engine of claim 1 wherein each converter of said plurality of converters includes a plurality of transistors.

4. The internal combustion engine of claim 1 wherein each converter of said plurality of converters includes a monostable flip-flop.

5. The internal combustion engine of claim 4 wherein a pulse of a specified voltage must be present for operation of said monostable flip-flop.

6. The internal combustion engine of claim 5 wherein each converter of said plurality of converters is constructed and arranged for maintaining a desired spark timing by cancelling an output of said monostable flip-flop.

7. The internal combustion engine of claim 1 wherein each converter of said plurality of converters is constructed and arranged with a printed circuit board which is mechanically packaged for directly mounting to a corresponding capacitive discharge ignition coil.

8. A capacitive discharge coil converter for managing the operation of a capacitive discharge ignition coil of an internal combustion engine, said converter comprising:
an electronic circuit constructed and arranged on a printed circuit board and including circuit manes for producing a shorter, usable pulse for its corresponding capacitive discharge ignition coil; and
a mechanical package for creating a connection to said capacitive discharge ignition coil.

9. The capacitive discharge coil converter of claim 8 wherein said electronic circuit includes a plurality of nand gates

10. The capacitive discharge coil converter of claim 8 wherein said electronic circuit includes a plurality of transistors.

11. The capacitive discharge coil converter of claim 8 wherein each converter of said plurality of converters includes a monostable flip-flop.

12. The capacitive discharge coil converter of claim 11 wherein a pulse of a specified voltage must be present for operation of said monostable flip-flop.

13. The capacitive discharge coil converter of claim 12 wherein each converter of said plurality of converters is constructed and arranged for maintaining a desired spark timing by cancelling an output of said monostable flip-flop.

14. A method of modifying an internal combustion engine which includes a digital inductive ignition system and a plurality of capacitive discharge ignition coils, said method comprising the following steps:
(a) providing a plurality of capacitive discharge coil converters, each converter of said plurality of converters is constructed and arranged for producing a shorter, usable pulse for its corresponding capacitive discharge ignition coil;
(b) electrically connecting said digital inductive ignition system to each converter of said plurality of converters; and
(c) electrically connecting each converter of said plurality of converters to a corresponding one of said plurality of capacitive discharging ignition coils.

15. The method of claim 14 wherein each converter of said plurality of converters includes a monostable flip-flop and comprises the further step of introducing a pulse to the monostable flip-flop to maintain a desired spark timing.

16. A capacitive discharge coil converter for managing the operation of a capacitive discharge ignition coil of an internal combustion engine, said converter comprising:
an electronic circuit constructed and arranged on a printed circuit board and including a monostable flip-flop; and
a mechanical package for creating a connection to said capacitive discharge ignition coil.

17. The capacitive discharge coil converter of claim 16 wherein said electronic circuit includes a plurality of nand gates

18. The capacitive discharge coil converter of claim 16 wherein said electronic circuit includes a plurality of transistors.

19. The capacitive discharge coil converter of claim 16 wherein a pulse of a specified voltage must be present for operation of said monostable flip-flop.

20. The capacitive discharge coil converter of claim 16 wherein each converter of said plurality of converters is constructed and arranged for producing a shorter, usable pulse for its corresponding capacitive discharge ignition coil.

21. The capacitive discharge coil converter of claims 16 wherein each converter of said plurality of converters is constructed and arranged for maintaining a desired spark timing by cancelling an output of said monostable flip-flop.
